(19) United States
(12) Patent Application Publication
(10) Pub. No.: US 2008/0227489 A1
(43) Pub. Date: Sep. 18, 2008

(54) METHOD AND SYSTEM FOR PROVIDING MULTI-STYLE USER INTERFACE FOR MOBILE TERMINAL

(75) Inventor: Moon Ki HUH, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/032,050

(22) Filed: Feb. 15, 2008

(30) Foreign Application Priority Data
Mar. 15, 2007 (KR) 2007-0025465

(51) Int. Cl. H04M 1/21

(52) U.S. Cl. 455/556.1

(57) ABSTRACT

A method for providing a multi-style user interface for a mobile terminal is provided. The multi-style user interface providing method includes importing first user data of a first mobile terminal; converting the imported first user data into second user data having a format compatible with a database of a second mobile terminal; and storing the second user data in the database of the second mobile terminal. As a result, data compatibility between mobile terminals manufactured by different companies is enhanced through data synchronization. In addition, the user can select a desired user interface style, thereby reducing the burden of learning a new user interface.

### PRIORITY

This application claims priority under 35 U.S.C. §119(a) to a Korean Patent Application entitled “METHOD AND SYSTEM FOR PROVIDING MULTI-STYLE USER INTERFACE FOR MOBILE TERMINAL” filed in the Korean Intellectual Property Office on Mar. 15, 2007 and assigned Serial No. 2007-0025465, the contents of which are incorporated herein by reference.

### BACKGROUND OF THE INVENTION

1. Field of the Invention

The present invention relates generally to a mobile terminal, and in particular, to a method and system of providing a multi-style user interface for a mobile terminal, wherein data compatibility between mobile terminals manufactured by different companies is enhanced.

2. Description of the Related Art

Synchronization Markup Language (SyncML) is a data synchronization protocol for mobile devices such as Personal Digital Assistants (PDAs) and mobile phones. SyncML is a standard protocol developed by the Open Mobile Alliance (OMA), which is a standardization body that develops open standards for the mobile phone industry. Particularly, SyncML aims to support effective personal information management for mobile terminals in wired and wireless communication environments.

However, because the specification of SyncML may fail to fully reflect specific needs of supporters and be ambiguous, development of middleware using SyncML is difficult. Hence, mobile terminals supporting the full SyncML specification are difficult to manufacture, and data synchronization between mobile terminals manufactured by different companies is not easy.

In particular, the degree of data mobility or compatibility between mobile terminals that are manufactured before the introduction of SyncML or do not support SyncML is very low, thereby complicating data exchange between mobile terminals. When a user buys a new mobile terminal, which is manufactured by a company different from that of the existing mobile terminal, movement of user data (for example, phonebooks, messages, photographs, and moving images) stored in the existing mobile terminal to the new mobile terminal is not easy. Further, the user interface, including character input and menu composition schemes, of the new mobile terminal may be different from that of the existing mobile terminal, thereby causing inconvenience to the user.

### SUMMARY OF THE INVENTION

An aspect of the present invention is to substantially solve at least the above problems and/or disadvantages and to provide at least the advantages below. Accordingly, one aspect of the present invention is to provide a method and system for providing a multi-style user interface for a mobile terminal, wherein data compatibility between mobile terminals manufactured by different companies is enhanced.

According to one aspect of the present invention, there is also provided a method and system for providing a multi-style user interface for a mobile terminal, wherein user data in an old mobile terminal can be easily moved to a new mobile terminal through data conversion.

According to another aspect of the present invention, there is further provided a method and system for providing a multi-style user interface for a mobile terminal, wherein the user can select a desired user interface style.

According to one aspect of the present invention, there is provided a multi-style user interface providing method for a mobile terminal. The method includes importing first user data of a first mobile terminal; converting the imported first user data into second user data having a format compatible with a database of a second mobile terminal; and storing the second user data in the database of the second mobile terminal.

According to another aspect of the present invention, there is provided a multi-style user interface providing system. The system includes a first mobile terminal for providing a first user interface and storing first user data; a synchronization module for importing the first user data from the first mobile terminal and converting the imported first user data into second user data having a format compatible with a second mobile terminal; and a second mobile terminal for receiving the second user data and storing the received second user data in a database.

According to yet another aspect of the present invention, there is provided a multi-style user interface providing apparatus for a mobile terminal. The apparatus includes a data synchronizer for performing data synchronization between imported user data and existing user data; a database for storing synchronized user data; a user interface area for storing information regarding multiple user interface styles; and a control unit for reconfiguring a multi-style user interface according to a user interface style selected by a user and for providing the reconfigured multi-style user interface to the user.

### BRIEF DESCRIPTION OF THE DRAWINGS

The above and other objects, features and advantages of the present invention will be more apparent from the following detailed description in conjunction with the accompanying drawings, in which:

FIG. 1 illustrates a system of providing a multi-style user interface for a mobile terminal according to the present invention;

FIG. 2 illustrates a configuration of a mobile terminal according to another embodiment of the present invention;

FIG. 3 is a sequence diagram illustrating a method of providing a multi-style user interface according to the present invention;

FIG. 4 is a flow chart illustrating the method of FIG. 3; and

FIGS. 5A and 5B illustrate screen representations of the method as illustrated in FIG. 4.

### DETAILED DESCRIPTION OF THE PREFERRED EMBODIMENTS

Hereinafter, exemplary embodiments of the present invention are described in detail with reference to the accompanying drawings. The same reference symbols identify the same or corresponding elements in the drawings. Detailed descriptions of constructions or processes known in the art may be omitted to avoid obscuring the invention in unnecessary detail.

Although, for the purpose of description, a mobile communication terminal is described as an example of a mobile terminal of the present invention, the present invention is not limited to a mobile communication terminal. The mobile terminal of the present invention is a terminal that can store user data and provide information using the stored user data, and may be any information and communication appliance or multimedia appliance, such as a mobile communication terminal, mobile phone, Personal Digital Assistant (PDA), smart phone, International Mobile Telecommunications 2000 (IMT 2000) terminal, Universal Mobile Telecommunications System (UMTS) terminal, digital broadcast receiving terminal, notebook, or personal computer.

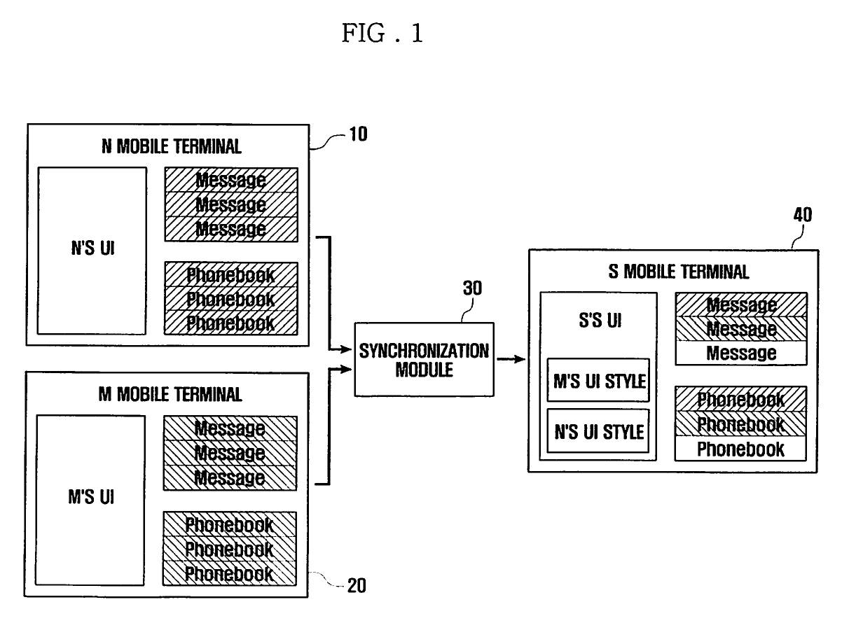

FIG. 1 illustrates a system of providing a multi-style user interface for a mobile terminal according to an exemplary embodiment of the present invention.

In FIG. 1, a system of providing a multi-style User Interface (UI) (i.e., multi-style UI providing system) includes: an N mobile terminal 10 that is manufactured by the company ‘N’, stores user data including messages and phonebooks, and provides its own UI; an M mobile terminal 20 that is manufactured by the company ‘M’, stores user data including messages and phonebooks, and provides its own UI; a synchronization module 30 that imports user data from the N mobile terminal 10 or the M mobile terminal 20 and converts the imported user data; and an S mobile terminal 40 that is manufactured by the company ‘S’, provides a multi-style UI, imports user data converted by the synchronization module 30, and configures the multi-style UI according to a UI style selected by the user.

The N mobile terminal 10 stores user data including messages and phonebooks, and provides a UI designed by the company ‘N’. The M mobile terminal 20 also stores user data including messages and phonebooks, and provides a UI designed by the company ‘M’.

The synchronization module 30 can establish a wired or wireless connection to the N mobile terminal 10 and M mobile terminal 20, and also establish a wired or wireless connection to the S mobile terminal 40. The synchronization module 30 imports user data from the N mobile terminal 10 or M mobile terminal 20, and converts the imported user data into target user data having a format compatible with the S mobile terminal 40. The synchronization module 30 identifies the design model and manufacturer of the connected N mobile terminal 10 or M mobile terminal 20, and uses a data import protocol compatible with the identified design model and manufacturer. Thereto, the synchronization module 30 includes information regarding structures of user data of mobile terminals different in design model and manufacturer, and data import protocols compatible with different mobile terminals. The synchronization module 30 may be implemented using software synchronization tools for personal computers, and be included in a personal computer or a mobile terminal such as the S mobile terminal 40.

The S mobile terminal 40 stores converted user data from the synchronization module 30 in a database. If different versions of the same data record are present in the database and the converted user data, the S mobile terminal 40 performs data synchronization. The S mobile terminal 40 provides a multi-style UI supporting various UI styles selectable by the user. For example, if the user selects the N's UI style for use, the S mobile terminal 40 configures the multi-style UI so as to support the N's UI style.

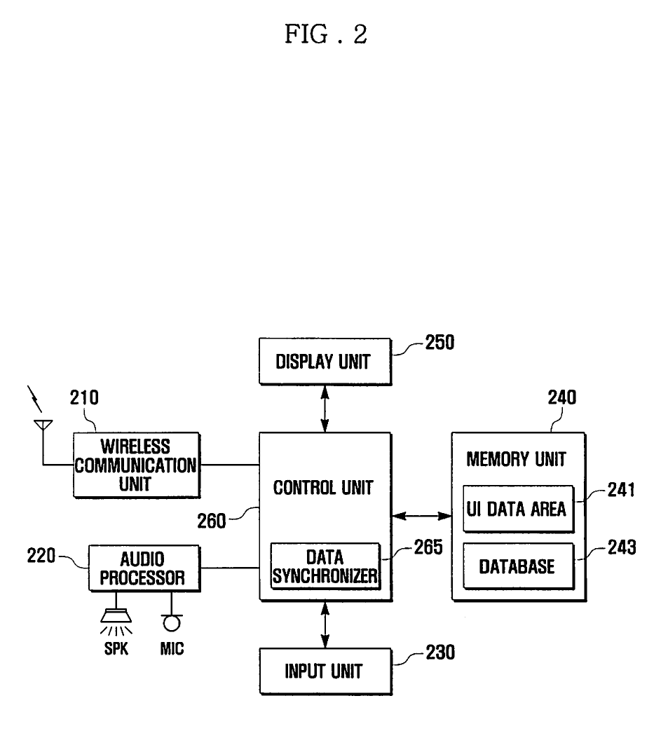

FIG. 2 illustrates a configuration of a mobile terminal (for example, the S mobile terminal 40 in FIG. 1) according to another exemplary embodiment of the present invention.

In FIG. 2, the mobile terminal of the present invention includes a wireless communication unit 210, audio processor 220, input unit 230, memory unit 240, display unit 250, and control unit 260.

The wireless communication unit 210 performs wireless transmission and reception operations for the mobile terminal to send and receive a signal carrying user data such as a text message and phone call to and from another mobile terminal. The wireless communication unit 210 includes a Radio Frequency (RF) transmitter for up-converting the frequency of a signal to be transmitted and amplifying the signal, and an RF receiver for low-noise amplifying a received signal and down-converting the frequency of the received signal. The wireless communication unit 210 converts a modulated signal from the control unit 260 into an intermediate frequency signal, further converts the intermediate frequency signal into an RF signal, and transmits the RF signal through an antenna to a corresponding base station. The wireless communication unit 210 converts an RF signal received through the antenna from a corresponding base station into an intermediate frequency signal, further converts the intermediate frequency signal into a baseband signal, and sends the baseband signal to the control unit 260.

The audio processor 220 reproduces an audio signal from the control unit 260 through a speaker SPK, and sends an audio signal such as a voice signal from a microphone MIC to the control unit 260. That is, the audio processor 220 converts an analog voice signal from the microphone MIC into a digital signal using Pulse Code Modulation (PCM), and sends the PCM signal to the control unit 260. The audio processor 220 also converts a PCM signal, carrying voice data of the other party, from the control unit 260 into an audible analog signal, and outputs the audible analog signal to the speaker SPK.

The input unit 230 includes a plurality of alphanumeric and function keys for inputting alphanumeric information and for setting various functions. The function keys may include direction, side, and shortcut keys associated with corresponding functions. The input unit 230 transmits key signals from the user for setting and controlling the mobile terminal to the control unit 260. Preferably, the input unit 230 includes a shortcut key or a camera key at a side of the mobile terminal for photographing using a camera module (not shown).

The memory unit 240 stores application programs supporting functions necessary for the present invention, downloaded digital contents, and user generated data. The memory unit 240 provides a buffer space for executing application programs. The memory unit 240 may include a program memory section and a data memory section.

The program memory section stores an operating system for booting the mobile terminal, application programs for text messages and call processing, and application programs for supplementary functions related to photographing and detecting target objects, and to the playing of audio and video data. When one of these functions is activated in response to a user request, the mobile terminal executes a corresponding application program under the control of the control unit 260.

The data memory section stores user data generating from operation of the mobile terminal. In particular, the data memory section includes a UI data area 241 and a database 243. The UI data area 241 stores UI information regarding a native multi-style UI and other companies' UIs. The database 243 stores various user data such as phonebooks and text messages, and provides customized data to the multi-style UI.

The display unit 250 displays on a screen visual data from the control unit 260. The display unit 250 displays various menus of the mobile terminal, information input by the user, and information to be provided to the user such as function-setting data. The display unit 250 displays information in a UI style set by the control unit 260.

The display unit 250 may include a panel of Liquid Crystal Display (LCD) devices, LCD controller, and memory device for storing image data to be displayed. In this case, if the panel has a touch screen capability, the display unit 250 can also act as an input means.

The control unit 260 controls the overall operation and signal exchange between internal elements of the mobile terminal. That is, the control unit 260 controls signal exchange between the wireless communication unit 210, audio processor 220, input unit 230, memory unit 240, and display unit 250.

The control unit 260 performs operations according to key signals from the input unit 230, and displays current status data and necessary menus through the display unit 250.

The control unit 260 can include a data synchronizer 265 for converting user data imported from another mobile terminal into data suitable for storage in the database 243. The data synchronizer 265 may be implemented as a software program.

In call processing, the control unit 260 converts a PCM audio signal from the audio processor 220 through channel coding, interleaving, and modulation into a signal to be transmitted, and sends the signal to the wireless communication unit 210. The control unit 260 also converts a received signal from the wireless communication unit 210 through demodulation, equalization, channel decoding, and deinterleaving into a PCM audio signal, and sends the PCM audio signal to the audio processor 220. Thereto, the control unit 260 may include a modulator/demodulator (modem) and a coder/decoder (codes). The codec may have a data codec for processing packet data, an audio codec for processing an audio signal such as a voice signal, and a video codec for processing a video signal carrying still and moving images.

Although not shown, for the purpose of digital convergence, the mobile terminal of the present invention may further include at least one of a camera module, digital broadcast receiving module, digital audio player, media connector for installing an external storage device such as a memory card, and other supplementary connectors for external devices such as a digital appliance and electric charger.

For voice communication, when the user inputs a phone number through the input unit 230 and enters a call (Send) key, the control unit 260 of the mobile terminal changes mode to a transmission mode, and places a call to a called mobile terminal using the phone number through the wireless communication unit 210. Then, the control unit 260 receives an answer signal from the called mobile terminal through the wireless communication unit 210, and outputs the received answer signal to the speaker SPK of the audio processor 220. Thereby, the control unit 260 establishes a voice call connection to the called mobile terminal in the transmission mode.

When the wireless communication unit 210 receives an incoming call, the control unit 260 changes modes to a reception mode, and generates a ring tone through the audio processor 220. If the user answers the incoming call, the control unit 260 establishes a voice call connection to a calling mobile terminal in the reception mode.

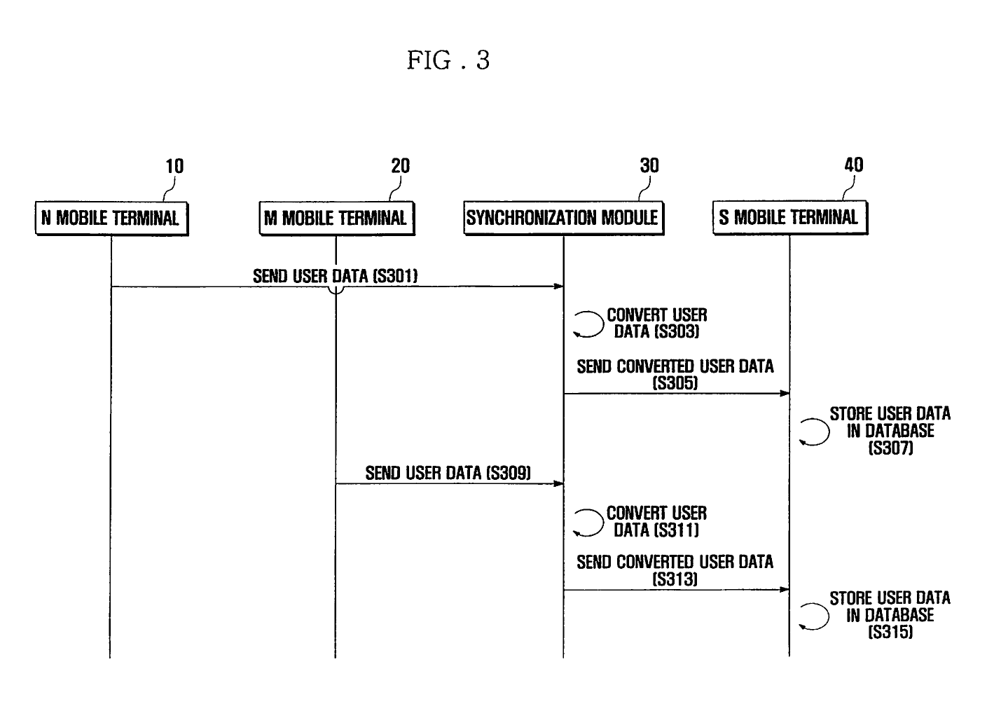

FIG. 3 is a sequence diagram illustrating a method of providing a multi-style user interface according to another exemplary embodiment of the present invention.

In FIG. 3, the N mobile terminal 10 sends user data including messages and phonebooks to the synchronization module 30 in step S301. The synchronization module 30 identifies the design model and manufacturer of the N mobile terminal 10 connected through a wired or wireless link, and uses a data import protocol compatible with the identified design model and manufacturer for reception of the user data.

The synchronization module 30 converts the imported user data into target user data having a format compatible with the S mobile terminal 40 connected through a wired or wireless link in step S305. Thereto, the synchronization module 30 may include information regarding structures of user data of mobile terminals different in design model and manufacturer, and data import protocols compatible with different mobile terminals.

The synchronization module 30 sends the target user data to the S mobile terminal 40 in step S305.

The S mobile terminal 40 receives the target user data from the synchronization module 30, and stores the received target user data in a database in step S307. If different versions of the same data record are present in the database and the target user data, the S mobile terminal 40 performs data synchronization. In addition, the S mobile terminal 40 provides a multi-style UI supporting various UI styles selectable by the user. For example, if the user selects the N's UI style for use, the S mobile terminal 40 configures the multi-style UI so as to support the N's UI style.

In a manner similar to that of the N mobile terminal 10, the M mobile terminal 20 sends user data including messages and phonebooks to the synchronization module 30 in step S309.

The synchronization module 30 converts the imported user data from the M mobile terminal 20 into target user data having a format compatible with the S mobile terminal 40 in step S311.

The synchronization module 30 then sends the target user data to the S mobile terminal 40 in step S313.

The S mobile terminal 40 receives the target user data from the synchronization module 30, and stores the received target user data in the database in step S315. However, if different versions of the same data record are present in the database and the received target user data, the S mobile terminal 40 performs data synchronization.

In addition, the S mobile terminal 40 provides the multi-style UI supporting various UI styles selectable by the user. For example, if the user selects the M's UI style for use, the S mobile terminal 40 configures the multi-style UI so as to support the M's UI style.

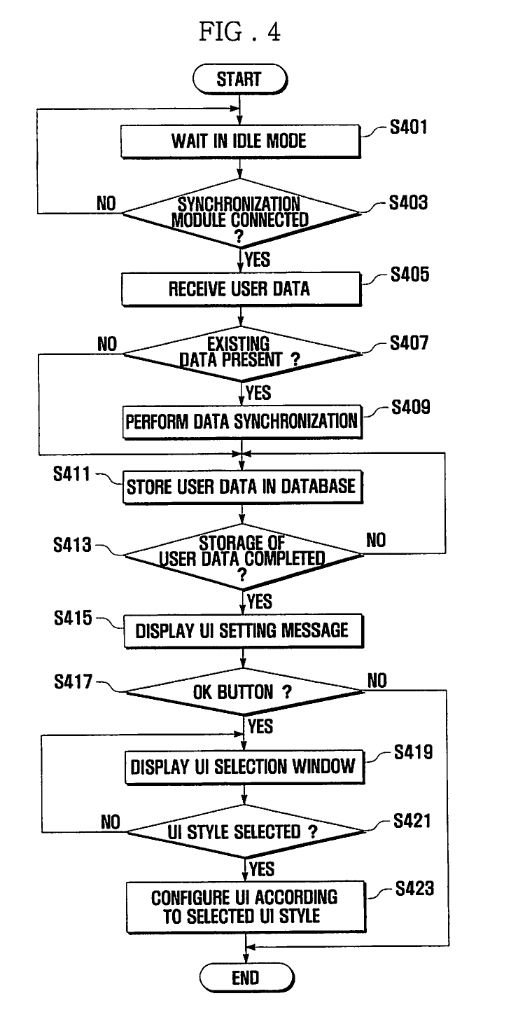

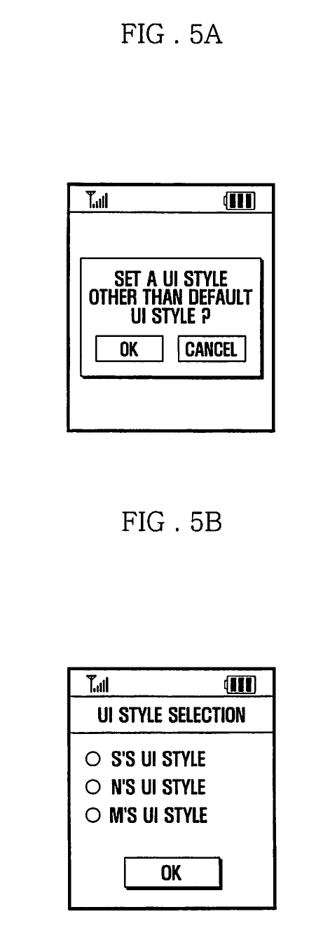

FIG. 4 is a flow chart illustrating the multi-style UI providing method of FIG. 3. FIGS. 5A and 5B illustrate screen representations of the method as illustrated FIG. 4.

In FIG. 4, the mobile terminal awaits occurrence of an event in an idle mode in step S401. When the synchronization module 30 is connected to the mobile terminal in step S403, the control unit 260 receives user data from the synchronization module 30 in step S405.

The control unit 260 determines whether different versions of the same data record are present in the database and the received user data in step S407. If different versions of the same data record are present in the database and the received user data, the control unit 260 performs data synchronization in step S409, and stores the synchronized data record in the database with updating the existing data record in step S411. In step S409, for data synchronization, the data synchronizer 265 can parse the received user data into data records, and compare fields of each data record with those of a corresponding existing data record.

If different versions of the same data record are not present at step S407, the control unit 260 stores the received user data in the database without additional processing in step S411.

When storage of the received user data is completed in step S413, the control unit 260 displays a UI setting message as illustrated in FIG. 5A in step S415. The control unit 260 checks a user response to the UI setting message in step S417. If the user enters the ‘OK’ button, the control unit 260 displays a UI selection window as illustrated in FIG. 5B in step S419.

In the UI selection window of FIG. 5B, the user can select one of the S's UI style, N's UI style, and M's UI style using radio buttons.

When the user selects a UI style in step S421, the control unit 260 configures the native multi-style UI so as to support the selected UI style in step S423.

If the user enters the ‘Cancel’ button at step S417, the native multi-style UI is used without additional setting.

Use of the multi-style UI is described in relation to text messages. When the user selects a text message menu item in a main menu, the control unit 260 displays a list of lower-level menu items of the text message menu item. The lower-level menu items may be related to received text message listing, text message composition, multimedia message composition, and spam message management. Here, menu structures may be different for different companies. For example, the S's UI may have a menu structure of three levels (message—text message—message box), and the N's UI may have a menu structure of two levels (text message—message box).

When the user selects the menu item of received text message listing, the control unit 260 displays a list of received text messages. A number of attributes such as title, reception time, sender phone number can be displayed for each text message. Here, displayed attributes may be different for different companies.

In addition, shortcut keys for received text message listing may also be different from company to company.

The mobile terminal of the present invention provides a multi-style UI supporting various UI styles selectable by the user. The burden of learning a new UI style due to, for example, differences of menu structures and levels is reduced, and the user can use the mobile terminal with a familiar UI style.

As apparent from the above description, the present invention provides a method and system for providing a multi-style user interface for a mobile terminal, wherein data compatibility between mobile terminals manufactured by different companies is enhanced through data synchronization. In addition, the user can select a desired user interface style, thereby reducing the burden of learning a new user interface.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. A multi-style user interface providing method for a mobile terminal, the method comprising:
importing first user data of a first mobile terminal;
converting the imported first user data into second user data having a format compatible with a database of a second mobile terminal; and
storing the second user data in the database of the second mobile terminal.

2. The method of claim 1, further comprising performing, if different versions of the same data record are present in the database and the imported first user data, data synchronization before storage of the data record.

3. The method of claim 1, wherein the second mobile terminal provides a multi-style user interface that supports multiple user interface styles including that of the first mobile terminal.

4. The method of claim 3, further comprising selecting, by a user, one of the multiple user interface styles.

5. The method of claim 4, further comprising reconfiguring the multi-style user interface so as to support the selected user interface style.

6. A multi-style user interface providing system comprising:
a first mobile terminal for providing a first user interface and storing first user data;
a synchronization module for importing the first user data from the first mobile terminal and converting the imported first user data into second user data having a format compatible with a second mobile terminal; and
the second mobile terminal for receiving the second user data and storing the received second user data in a database.

7. The system of claim 6, wherein the synchronization module comprises information regarding user data of the first mobile terminal and second mobile terminal for data conversion.

8. The system of claim 6, wherein the second mobile terminal performs, if different versions of the same data record are present in the database and the second user data, data synchronization before storage of the data record.

9. The system of claim 6, wherein the second mobile terminal provides a multi-style user interface that supports multiple user interface styles including that of the first mobile terminal.

10. The system of claim 9, wherein the second mobile terminal reconfigures the multi-style user interface according to a user interface style selected by a user.

11. A multi-style user interface providing apparatus for a mobile terminal, the apparatus comprising:
a data synchronizer for performing data synchronization between imported user data and existing user data;
a database for storing synchronized user data;
a user interface area for storing information regarding multiple user interface styles; and
a control unit for reconfiguring a multi-style user interface according to a user interface style selected by a user and for providing the reconfigured multi-style user interface to the user.

12. The apparatus of claim 11, further comprising a display unit for displaying screen windows according to the selected user interface style.
